(19) United States
(12) Patent Application Publication
(10) Pub. No.: US 2006/0123991 A1
(43) Pub. Date: Jun. 15, 2006

(54) Adsorption filter

(75) Inventors: Volker Braeunling, Heppenheim (DE); Ulrich Stahl, Laudenbach (DE); Uwe Felber, Abtsteinbach (DE); Robert Bader, Heidelberg (DE); Heiko Schacht, Hirschberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/290,290

(22) Filed: Nov. 30, 2005

(30) Foreign Application Priority Data
Dec. 2, 2004 (DE) 10 2004 058 167.3

(51) Int. Cl. B01D 53/02

(52) U.S. Cl. 96/153

(57) ABSTRACT

An adsorption filter having at least one layer of activated carbon particles is, with regard to the object of refining an adsorption filter of the described type, to be refined in such a way that it has a distinctly improved penetration characteristic compared to conventional filters involving a configuration which is as simple and cost-effective as possible and that at least 20 percent by weight of the activated carbon particles have a particle size of less than 0.180 mm and that the total mass per unit area of activated carbon is between 100 g/m² and 500 g/m². The adsorption filter can provide a high spontaneous adsorption performance.

### BACKGROUND

This claims the benefit of German Patent Application No. 10 2004 058 167.3, filed Dec. 2, 2004 and hereby incorporated by reference herein.

### BACKGROUND

The present invention relates to an adsorption filter having at least one layer of activated carbon particles.

Elements known as combination filters are currently used in many systems, in motor vehicle air conditioning systems in particular. These are particle filters for trapping particles including a downstream activated carbon layer for adsorbing gases. As a rule, the activated carbon layer is composed of carbon grains which may be attached to a substrate made of nonwoven fabric, for example. The particle sizes and carbon amounts used represent a compromise between adsorption capacity, penetration characteristics, and air permeability. The grain sizes of the activated carbon particles used are typically in the range of 20×60 mesh (mesh size according to ASTM designation D 2862-97). This translates into particle sizes between 0.25 mm and 0.85 mm. Typical application amounts of activated carbon per surface unit are between 250 g/m²-500 g/m².

Numerous suggestions for improving the penetration behavior of an adsorption filter are known from the related art. As a rule, these are filter configurations in which a filter section having high spontaneous adsorption is added to a conventional adsorption filter including carbon grains or carbon balls.

An adsorption filter is known from German Patent No. 197 08 692, for example, which is divided into two filter sections for improving the penetration behavior while simultaneously maintaining the greatest possible level of air permeability and adsorption capacity. The first filter section is supposed to adsorb up to 99% of the pollutants and should therefore have a high capacity. The second section should have only a low capacity, but a high adsorption rate. The publication describes the use of granular activated carbon or ball-shaped activated carbon (particle size approximately 0.3 mm-1.0 mm; total carbon amount: approximately 400 g/m²-500 g/m²) as the adsorbent for the first section and preferably textile fabrics of activated carbon for the second section. U.S. Pat. No. 4,906,263, hereby incorporated by reference herein, also describes an adsorption filter.

Very good penetration characteristics should be achievable using the known filter. However, this filter and the other filters described in the publications have the disadvantage of, as a rule, a very complex and expensive configuration which is reflected in both the material costs as well as the manufacturing costs.

### BRIEF SUMMARY OF THE INVENTION

An object of the present invention is to refine an adsorption filter of the type mentioned above in such a way that it has clearly improved penetration characteristics compared to the conventional filters, with a configuration that is as simple and as cost-effective as possible.

The present invention provides that, in an adsorption filter which includes at least one layer of activated carbon particles, at least 20 percent by weight of the activated carbon particles have a particle size of less than 0.180 mm and that the total mass per unit area of activated carbon amounts to between 100 g/m² and 500 g/m².

The adsorption filter according to the present invention exhibits very good penetration characteristics. The adsorption rate was able to be substantially increased by using smaller particle sizes. The reduction of the particle size is typically accompanied by an undesirable decrease in the air permeability of the filter medium. According to the present invention, this is counteracted by the fact that the amount of activated carbon used is able to be reduced way below the amounts normally used at the expense of the adsorption capacity. Contrary to the notion prevailing in the related art that, in addition to a good adsorption rate, a high performance adsorption filter must also have an adsorption capacity that is as high as possible—that is why the high performance adsorption filter known from the above-mentioned German Patent No. 197 08 692 C2 has a section with a high adsorption rate as well as a section with a high proportion of activated carbon and thus a high adsorption capacity—the inventors have recognized that the level of the achievable adsorption capacity does not command the importance for the function of a filter as was previously assumed.

The inventors have recognized in particular that the pollution loads to be found in road traffic mostly occur only as short-term concentration peaks which may be very well eliminated by using a quickly responding adsorption filter having a high spontaneous adsorption rate and in which the adsorption capacity plays only a secondary role. Moreover, it has been found within the scope of endurance tests and subjective performance evaluations (DIN 10950: “sensory training” and DIN 13725: “olfactometry”) of combination filters having conventional adsorption filters that the level of the adsorption capacity according to DIN 71460/2 does not represent a measure for the filter endurance or the subjective odor reduction characteristic of combination filters.

According to the present invention, it has finally been recognized that an increase in the proportion of activated carbon particles to 20 percent by weight, which are smaller than 0.180 mm, already results in an appreciable improvement in the spontaneous adsorption. According to the present invention, the total mass per unit area of the activated carbon is between 100 g/m² and 500 g/m². These values represent a compromise between good air permeability of the filter medium and sufficient adsorption capacity. If the total mass per unit area of activated carbon falls below a value of 100 g/m², then the contact probability of the molecules to be adsorbed with the activated carbon is too low. The adsorption performance of the filter deteriorates as a result thereof and a channeling effect could occur. However, if the upper limit of 500 g/m² is exceeded, then the air permeability of the filter medium deteriorates too severely.

The present invention thus permits the suitable selection of the mixture of the application quantity made up of the fine portion and the coarse portion of activated carbon in such a way that a high adsorption rate is implementable with preferably good air permeability and filter action. To this end, the present invention also includes adsorption filters which include a mixture of activated carbon particles, the mixture including coarse and fine portions, and the mixture ratio of coarse portions and fine portions as well as the total quantity of the activated carbon particles being selected in such a way that the filter characteristics of the adsorption filter according to the present invention are implemented.

In a preferred embodiment of the present invention, at least 30 percent by weight, particularly preferred more than 50 percent by weight, of the activated carbon particles have a particle size of smaller than 0.180 mm. This further increases the adsorption rate, but the air permeability is still sufficiently good.

Very good values with regard to air permeability may still be achieved with a total mass per unit area of activated carbon of 250 g/m². Particularly good results with regard to penetration characteristics, air permeability, and adsorption capacity are achieved with a total mass per unit area of activated carbon between 150 g/m² and 230 g/m².

The activated carbon particles are preferably attached to a substrate of nonwoven fabric or embedded in such a nonwoven fabric. The techniques for this are known and widely described in the patent literature.

The adsorption filter could be used in particular in a combination filter of the type mentioned above, which includes a particle-filtering section, e.g., a particle filter made of nonwoven fabric which may be electrostatically charged, and a pollutant-adsorbing section.

The adsorption filter may also be used in combination with multiple particle filters and/or additional adsorption filters which may be directed toward specific pollutants and may have different adsorbent materials. The activated carbon particles and/or the adsorbent materials used in combination with the adsorption filter may, in a manner known per se, be treated partially or collectively with an acid, a catalyst, or a base.

The adsorption filter may have the same geometry as conventional filters, e.g., designed as a plate filter or a zigzag filter.

It is also conceivable that the adsorption filter is designed as a filter cartridge. This design makes a compact placement of the filter in a suitable housing possible.

The adsorption filter could be designed as a respirator filter. This design enables the use in places where substances are used which are harmful to the lungs.

The adsorption filter could be used, for example, as a component of a combination filter, in particular in automatic motor vehicle air conditioning systems. Such air conditioning systems are characterized to an increasing degree by the fact that, during high pollution loads or concentrations, the switch to recirculating air operation, in which the air supply from the outside is stopped and the air in the car interior is recirculated instead, takes place automatically. Pollution sensors are provided in the air intake for this purpose, which measure the pollution load or concentration of the sucked in air (particularly hydrocarbons and nitrogen oxides) and output a signal to the controller of the air conditioning system for closing the air circulation valve. This prevents high pollution concentrations in the ambient air from entering the passenger compartment. There is the problem here that a time period of several seconds elapses from the time when the pollution concentration enters the intake area and the pollution sensor outputs the signal until the complete closing of the air circulation valve and the pollutant in a high concentration is conducted into the air conditioning system and thus through the combination filter during this time. There is a great danger of the pollutant penetrating through the filter. It has been found that the adsorption filter according to the present invention has such a great spontaneous absorption performance that a penetration of pollutants into the passenger compartment during the system-related closing time of the air circulation valve of several seconds is largely prevented, even in the presence of high pollution concentrations. If the filter that is discussed here is used, this effect makes it possible to greatly simplify the design of air circulation valve systems, thereby slowing down their closing characteristics. This makes substantial cost savings possible. Moreover, in the event of a low pollution load which does not yet trigger the pollution sensor, the adsorption capacity of the adsorption filter according to the present invention is sufficient to adsorb the pollutants flowing through.

Sensors operate to some extent selectively and do not detect all molecules which are inherent in odors and pollutants. However, the adsorption filter could also adsorb all passing molecules when the sensor is not activated, thereby ensuring that no undesirable pollutants are able to occur.

Measures for desorption of the pollutants from the adsorption filter may also be provided, such as heating of the filter, e.g., by blowing hot air, or by increasingly blasting the filter, and the air, loaded with the pollutants, must be directed past the passenger compartment via a bypass line during the desorption process.

The adsorption filter also has advantages in connection with a manual operation of the air circulation valve.

In particular in connection with the possibility of switching to air circulation operation in the event of pollution loads, the adsorption filter according to the present invention exhibits, despite a smaller adsorption capacity which is ascertainable via measurement (according to DIN 71460/2), the same filter life as the known filters, since during actual use in the event of high pollution loads of the ambient air, the filter is “protected” due to the closing of the air circulation valve and the adsorption material is thus not loaded with pollutants. During air circulation operation, the adsorption filter may be situated either on the upstream side of the air circulation valve and the ambient air no longer streams through it when the air circulation valve is closed, or it may be situated downstream from the air circulation valve where only the vehicle interior air streams through it during air circulation operation. In contrast to known filters, the benefit, namely the subjective odor reduction, is clearly improved using the adsorption filter according to the present invention.

Although the properties and advantages of the adsorption filter according to the present invention are described above in connection with motor vehicle applications, the adsorption filter according to the present invention is by no means restricted to these applications. It may be used in all types of filter systems, e.g., also in air conditioning systems for climate control of spaces in buildings or in mobile indoor air purifiers.

### BRIEF DESCRIPTION OF THE DRAWINGS

The present invention will be explained in greater detail below based on exemplary embodiments and the drawings, in which:

FIG. 1. shows a diagram which compares a standard filter with kinetically optimized filters with regard to n-butane penetration measurements; and

FIG. 2 shows schematically an embodiment of a filter according to the present invention.

### DETAILED DESCRIPTION OF PREFERRED EMBODIMENTS

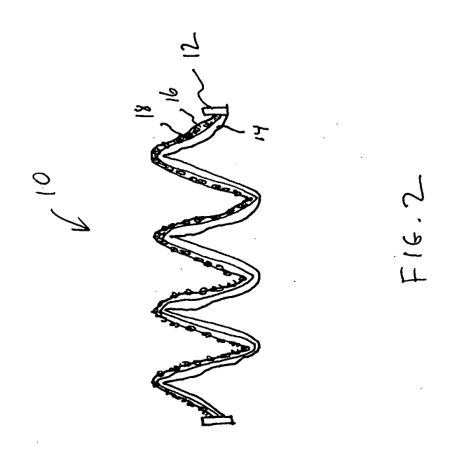

The n-butane penetration has been determined for three combination filters including adsorption filters having different quantities of activated carbon as well as for one standard commercially available combination filter. The filters were designed as known prefolded filters having a filter medium 10 folded in a zigzag shape and enclosed by a frame 12, as shown schematically in FIG. 2. All filters were made of non-wovens.

Manufacturing of a filter is subject to variations. It has to be taken into account here that the actual application quantity of activated carbon may deviate from the setpoint quantity by 20 g/m². The quantity of activated carbon particles whose size is below a certain particle size may deviate from the setpoint quantity by 10%.

The measurements have been executed according to the DIN 71460-2 standard for the adsorption of gases in effect for car passenger compartment filters.

The configuration of the filters in detail was as follows:

The combination filters had a one-layer particle filter 14 made of polypropylene (PP). The mass per unit area of the particle filter was 60 g/m² and the filter material was electrostatically charged. The fiber diameter was approximately 20 μm to 40 μm.

The chemical filter section 16 included a substrate made of polyester (PES) having a mass per unit area of approximately 43 g/m² and a fiber diameter of approximately 10 μm to 25 μm. This material was loaded with grainy activated carbon, identified schematically as 18. The mass per unit areas were 150 g/m², 200 g/m², and 250 g/m². The particle sizes were 0.106 mm to 0.425 mm. In this particle size distribution, more than 40 percent by weight of the particles were smaller than 0.180 mm.

The standard combination filter, used for comparison, had a one-layer particle filter having a filter layer made of polypropylene (PP) with an electrostatic charge, a mass per unit area of 60 g/m², and a fiber diameter of approximately 30 μm.

The chemical filter section included grainy activated carbon (0.25 mm to 0.6 mm) having a mass per unit area of 350 g/m². This grainy activated carbon was applied to a substrate made of PES having a mass per unit area of approximately 50 g/m². The particle size was 0.25 mm to 0.6 mm. For this particle size, only approximately 1 percent by weight of the particles were smaller than 0.180 mm.

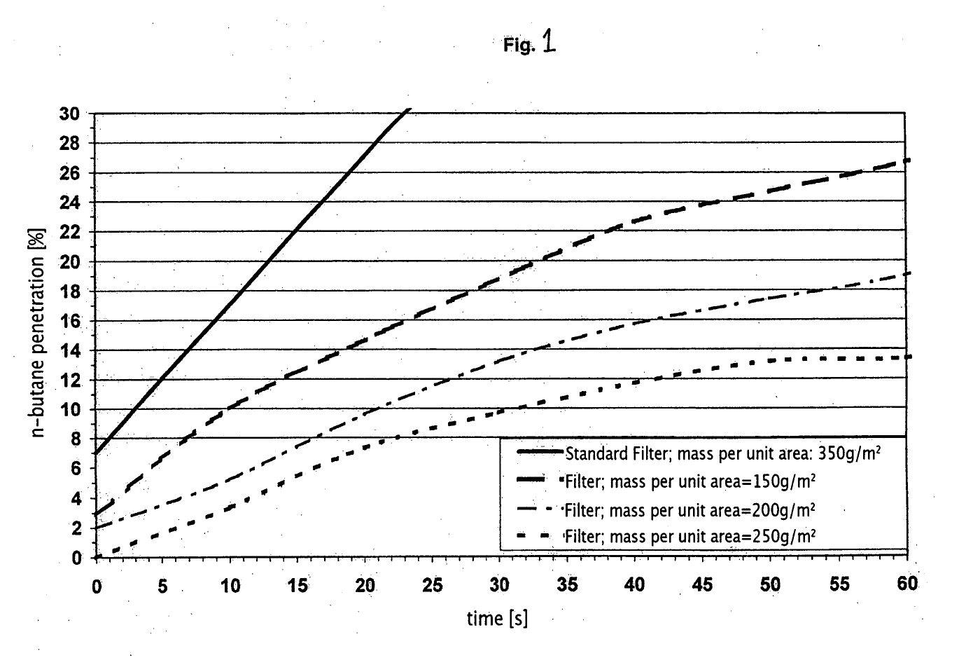

The result of the measurements is shown in FIG. 1.

The diagram of the figure represents measuring values which were detected during n-butane penetration measurements using four different filters. The tests were conducted in air with a temperature of 23° C. and 50% relative humidity. The penetration was 180 m³/h. The air was loaded with 80 ppm of n-butane.

It can be seen in the diagram of the figure that in the standard combination filter an instant penetration of approximately 7% takes place. This may indeed be slightly reduced due to the increase in the total quantity of activated carbon, but cannot be completely eliminated since the quantity of activated carbon cannot be increased arbitrarily due to the increasing pressure loss.

In the combination filters discussed here, the instant penetration is substantially lower as a function of the quantity of activated carbon, namely around 2% and 3% at a quantity of activated carbon of 150 g/m² and 200 g/m², respectively, and even reaches the value zero at 250 g/m². Furthermore, it should be noted that the increase in the penetration in standard filters is substantially steeper than in the adsorption filters discussed here. After a maximum time period of 10 seconds, assumed for closing an air circulation valve, the value of 17% for the n-butane penetration for the standard filter is relatively high and for filters having 150 g/m², 200 g/m² and 250 g/m² activated carbon the value of only 10%, 5%, and 3.5% is distinctly lower.

What is claimed is:

1. An adsorption filter comprising:
at least one layer of activated carbon particles, at least 20% of the activated carbon particles having a particle size of less than 0.180 mm and a mass per unit area of activated carbon being between 100 g/m² and 500 g/m².

2. The adsorption filter as recited in claim 1 wherein at least 30% of the activated carbon particles have a particle size of less than 0.180 mm.

3. The adsorption filter as recited in claim 2 wherein the mass per unit area of activated carbon is between 150 g/m² and 230 g/m².

4. The adsorption filter as recited in claim 1 wherein the mass per unit area of activated carbon is between 150 g/m² and 230 g/m².

5. The adsorption filter as recited in claim 4 further comprising a substrate for the activated carbon, the substrate including a non-woven material.

6. The adsorption filter as recited in claim 3 further comprising a substrate for the activated carbon, the substrate including a non-woven material.

7. The adsorption filter as recited in claim 2 further comprising a substrate for the activated carbon, the substrate including a non-woven material.

8. The adsorption filter as recited in claim 1 further comprising a substrate for the activated carbon, the substrate including a non-woven material.

9. A combination filter including an adsorption filter as recited in claim 1.

10. The combination filter as recited in claim 9 further comprising a material for a particle-filtering section, the material including a non-woven material.
